(19) United States
(12) Patent Application Publication
(10) Pub. No.: US 2008/0295110 A1
(43) Pub. Date: Nov. 27, 2008

(54) Framework for Startup of Local Instance of Remote Application

(76) Inventors: Fabrizio Muscarella, Mannheim (DE); Randolf Werner, Weisloch-Baiertal (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/752,856

(22) Filed: May 23, 2007

(51) Int. Cl. G06F 9/44

(52) U.S. Cl. 719/311

(57) ABSTRACT

Methods and apparatuses enable local execution of a remote application on a client device. An applet or plugin is started in response to beginning execution of a web browser. The applet includes code that initiates introspective invoking of the remote application from the web browser. The invoking may include accessing a remote server in response to starting execution of the applet, downloading functional components of the application from the server, and executing the application locally on resources of the client device. In one embodiment, the applet code includes dependencies on the functional components of the application on the server, which initiates the invoking of the components to enable execution of the applet.

### FIELD

Embodiments of the invention relate to execution of an application, and more particularly to locally executing an application accessed via a server.

### BACKGROUND

Applications are important in a business enterprise or company as a means for getting work done. Traditionally, applications are available under one or both of two scenarios. The first is that an application is located on a server within the company, and a user accesses the application via a client device or user machine. The application is executed remotely from the client device, on the server, and the results are provided to the client device. However, executing applications remotely can consume a great deal of network bandwidth within an organization, which requires infrastructure. Also, the greater the number of users, the greater the load on the server, which may degrade the performance of the server. Degraded performance may manifest itself through delays for a user.

The second scenario involves loading an application directly onto a user machine for execution locally on the machine. Having the application local to the client device can reduce the bandwidth consumption and execution delay problems that may be associated with executing the application remotely. However, there are other problems associated with installing and loading an application locally on a client device. When there are many users, the burden on support staff (e.g., system administrators) increases greatly. In order to keep current, each client device would need to be upgraded when application upgrades become available, which has a significant cost in terms of time and attention of the administrator. Both scenarios have advantages, but ultimately, each also has significant drawbacks.

### BRIEF DESCRIPTION OF THE DRAWING

The following description includes discussion of a figure having illustrations given by way of example of implementations of embodiments of the invention. The drawing should be understood by way of example, and not by way of limitation.

FIG. 1 is a block diagram of an embodiment of a system having an applet under a browser that locally begins execution of a remote application.

FIG. 2 is a block diagram of an embodiment of a system where beginning execution of a browser initiates execution of an applet that loads a remote application.

FIG. 3 is a block diagram of an embodiment of a system with an applet that begins execution of a remote application.

FIG. 4 is a flow diagram of an embodiment of a process of beginning local execution at a client device of a remote application.

### DETAILED DESCRIPTION

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

Methods and apparatuses enable local execution of a remote application on a client device. A generic plugin or applet starter framework enables the plugin or applet to start execution of a remote application. As used herein, a plugin refers to program code that interacts with a host or main application to provide certain functionality. The plugin is generally a binary, meaning the code is executable directly by the processor that executes the main application. A plugin is generally provided in a library or a directory allowing the plugin to be loaded by the main application when needed. A plugin generally provides a specific functionality, where the user interface is rendered in the user interface of the host application. An applet, as used herein, is a program that operates within the context of a host or main application/program. An applet generally is provided as code that is a higher-level language (e.g., JAVA), and is typically not directly executable by the processor. An applet is generally executed by a runtime engine (e.g., a JAVA virtual machine (JVM) engine) available to the main application. An applet is generally provided to the main application, which then executes the applet, rather than the main application specifically obtaining and executing the code, as with a plugin. Note that although there are technical distinctions between plugins and applets, similarities include providing extended functionality to a main application, and operating within a context of the application. In one embodiment, the main application can receive an instruction (via internal code or from outside the main application) that triggers the execution of a plugin or an applet. For purposes of discussing the functionality of enabling local execution of a remote application, the functionality of a plugin or applet, or similar technology, will be considered sufficiently similar that a discussion of the functionality of one can be applied to the functionality of another. The skilled reader will understand where distinctions exist. Thus, for purposes of simplicity in description, and not by way of limitation, the discussion herein will refer to an “applet,” but the skilled reader will understand the application of the discussion to a plugin.

In one embodiment, an applet is started in response to beginning execution of a web browser. For example, the web browser can be configured to load the applet. Alternatively, the applet may be invoked in response to seeking a particular address or network location with the web browser. In one embodiment, a web browser may be invoked via an icon in a user's workspace that causes a browser to open and pull content from a specified and/or configured location. As a specific example, an icon can represent the remote application that is desired to be started locally on the user's client device. Invoking the icon (e.g., “clicking on” the icon) can initiate the browser, which automatically looks to a network location for the remote application, which may invoke execution of the applet. In one embodiment, the remote application is a SWING application hosted from a server remote to, or separate from, the client device. A SWING application refers to an implementation of an application generated with a JAVA graphical user interface (GUI) toolkit that enables the building of a user interface with particular functionality. JAVA and SWING are available from SUN MICROSYSTEMS, Inc., of Santa Clara, Calif. All marks used herein are the property of their respective owners, and are used solely for purposes of identification.

The applet includes code that initiates introspective invoking of the remote application from the server from within the web browser. In one embodiment, the applet is initiated under a generic applet starter framework, which initiates the applet and invokes a control interface of a web service infrastructure. Although described herein as a web service infrastructure, it should be understood that the principles can be applied equally well to any control interface with any suitable protocol that may be used to provide a web service infrastructure. The control interface may employ a hypertext transfer protocol (HTTP) compliant protocol, or other transfer protocol. As an abbreviated reference, a server employing the protocol may be referred to as an HTTP server. The web service infrastructure refers to a system of interfaces and connections over a network that allow a web service connection with the server. In one embodiment, leveraging the control interface enables the applet to start any application deployed in a fixed deployment directory of the web service interface. Such an approach allows a remote application to be presented and started locally on the client device without additional development effort. Obtaining the application from the server and executing it on the local resources of the client device allows the client device to execute the application locally, and not have the performance restrictions and bandwidth requirements associated with running the application on the server.

Additionally, by having the client device access the application from the server, rather than having the application installed and executed directly on the client device reduces the maintenance costs associated with the application. Maintenance can take place in a single location (i.e., the server). Upgrades and changes can be provided on the server side and automatically propagated to the client devices through the remote access system. Every new instance of the application initiated on the client devices, as described, automatically updates the application. Thus, a simple restart of the application with the web browser on the client device provides the new upgrades, when the source on the server has been updated.

In one embodiment, the application can be made to automatically start locally by initiating or starting execution of the web browser by creating a generic applet class. The applet gets loaded by the browser when the browser gets started. Having the applet class allows the web service to provide functionality locally to the client device, rather than remotely executing the functionality on a server, as is performed with web services. In one embodiment, one or more functional components of the application that are located on the server are dependencies within the applet class, which causes the components to be automatically downloaded and executed when the applet is started. In the case of an applet, the browser has a JVM or other similar runtime engine installed to execute the applet. Thus, the browser starts the applet, which then starts the application, or retrieves a list from which an application to start is selected. In one embodiment, the applet reads a description file (e.g., .dsc of a directory of .jar files) and starts a selected application as a class (every JAVA application is typically started as a main class). The application then runs or executes locally on the client device.

As mentioned above, the applet may be capable of introspection invoking the application. As used herein, introspection refers to a capability of some object oriented programming languages to determine a type of an object at runtime. Essentially, there is an “introspection” mechanism that allows a program to Invoke( ) an application and change one or more values or configuration parameters of the application at runtime to allow the application to run. In one embodiment, the applet generates an HTTP “get” command to invoke the web service infrastructure. The command can access the server where the application can be downloaded. In one embodiment, issuing the command triggers a download of the application, after which it will start execution via the applet.

In one embodiment, the server includes one or more directories where application components are hosted. An application can be selected via a particular “get” command, or a general list of available applications can be provided in response to a general “get” command. A selected application (either selected from the list, or selected via a specific get command) downloads the application components. The server may have a directory that is accessed by the applet, and the directory has separate sub-directories of the service interface that each represents an application. The contents of the sub-directories are the components of the application.

In one embodiment, after downloading the components of the application to be executed locally on the client device, the client device can cease connection with the server on which the application is hosted. The client device can be disconnected from the server via closing the connection through the web service interface or other connecting interface. The client device could even be removed from the network entirely, such as unplugging from the network. Note a significant distinction in such an approach from that of a thin client or dumb terminal. The client device as contemplated herein has local resources on which the application is executed, and the client device can be disconnected from the network, as opposed to what is previously known with thin clients.

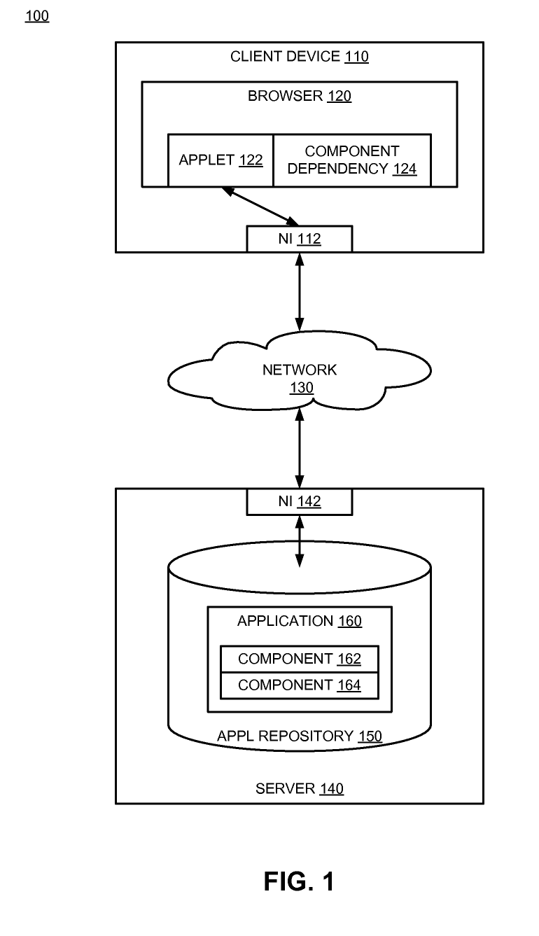

FIG. 1 is a block diagram of an embodiment of a system having an applet under a browser that locally begins execution of a remote application. System 100 includes client device 110, which represents any of a number of hardware devices that may access a remote application as described herein. Client device 110 may be, for example, a desktop or laptop computer, a workstation, a server device that can load an application remotely from another server, a handheld device such as a PDA (personal digital assistant) or palmtop computer, etc. As described in more detail below, client device 110 includes its own resources for executing an application, including an operating system or similar management/control system.

Client device 110 includes browser 120 executing on the local system resources. Browser 120 represents any type of program that enables access and interaction with a network, whether local (e.g., local area network (LAN)) or wide-area (e.g., the Internet). In one embodiment, browser 120 includes applet 122, which can be configured to execute in response to starting browser 120, or can be executed in response to selection of a certain web page or file. Applet 122 is an applet according to any described herein, and provides access functionality to browser 120 to utilize a server interface infrastructure. For example, the server interface infrastructure may be a web service interface infrastructure. Via applet 122, browser 120 accesses server 140 to access an application that will be executed locally on client device 110.

In one embodiment, applet 122 includes component dependency 124, which is a dependency within execution code of applet 122 on one or more components of an application hosted on server 140. Thus, executing applet 122 may automatically invoke downloading or accessing the components of the application to be executed locally. Client device 110 include network interface (NI) 112, which represents one or more elements that provide a connection to network 130. As suggested above, network 130 may be any form of network, whether local or wide-area, and may be interfaced wirelessly or through a wired connection. Network interface 112 may include hardware components (e.g., connectors, circuits, cables, antennas, etc.) as well as software elements (e.g., drivers, protocol stacks, port managers, etc.).

Server 140 includes network interface 142, which another example of a network interface similar to what is described with respect to network interface 112. Network interface 142 can enable a remote or separate (e.g., physically, geographically) machine to access application (appl) repository 150. Application repository 150 represents a database or storage on which one or more applications are stored and hosted by server 140. Essentially, application repository 150 represents physical storage on which data/code is stored, the storage being managed according to a file or data management system. The management system can be a filesystem or a web service infrastructure. In one embodiment, an access request by browser 120 via applet 122 accesses a directory or list of applications available from application repository 150, for example, application 160 and possibly other applications not shown. In another embodiment, the request by browser 120 via applet 122 directly requests application 160.

Application 160 includes multiple components, represented by components 162 and 164. What is illustrated is purely representational, seeing that a typical application will include more than two components. Components 162 and 164 may be stored in any format, and may be compressed. In one embodiment, components 162 and 164 are .jar files that include one or more software modules of application 160. For example, application 160 can be separated by executables, library files, configuration files, etc. In response to an access request by applet 122, the components are downloaded to client device 110, and executed on the resources of client device 110, typically under browser 120 via applet 122.

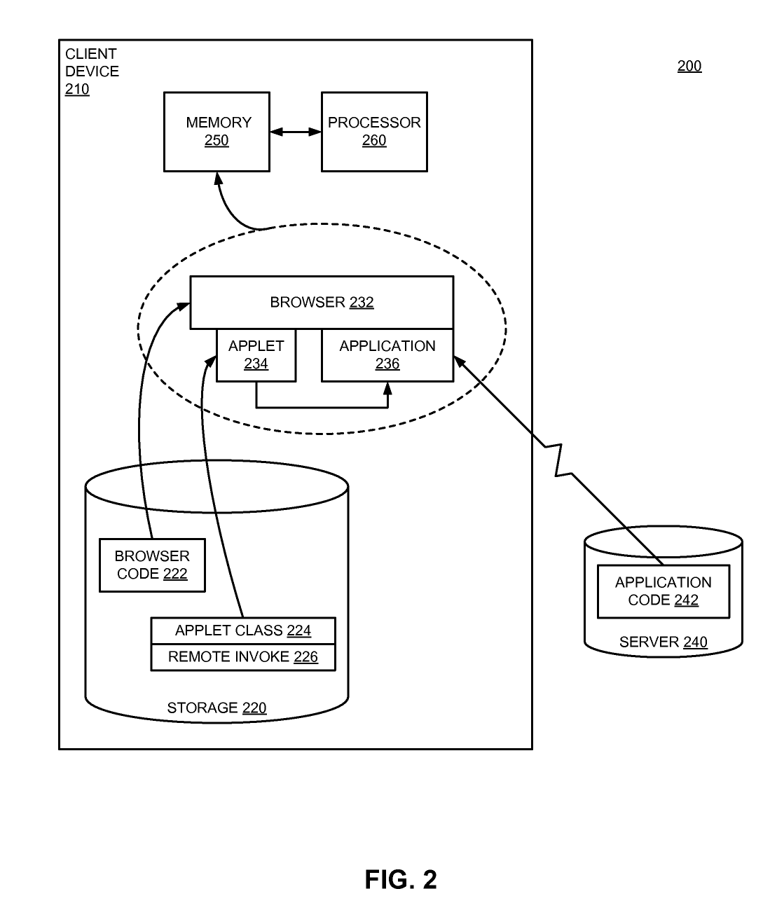

FIG. 2 is a block diagram of an embodiment of a system where beginning execution of a browser initiates execution of an applet that loads a remote application. System 200 provides an example of a system according to system 100 of FIG. 1. Similar components may be understood as being examples of embodiments described above. Client device 210 includes hardware and software resources that enable client device 210 to locally execute applications.

Memory 250 represents the main memory of client device 210, and provides temporary storage for code and/or data to be executed by processor 260. Memory 250 may include read-only memory (ROM), flash memory, one or more varieties of random access memory (RAM, e.g., static RAM (SRAM), dynamic RAM (DRAM), synchronous DRAM (SDRAM), etc.), or a combination of memory technologies. Client device 210 includes one or more processors 260, which control the operation of client device 210. Processor 206 may include any type of microprocessor, central processing unit (CPU), or programmable general-purpose or special-purpose microprocessors. An operating system provides an operating environment for client device 210, and manages the physical and software resources of client device 210. The operating system is executed by processor 260 out of memory 250 (which may include virtual memory).

Client device 210 also includes storage 220, which represents non-volatile storage in the client device. Whereas memory 250 is generally volatile, meaning it loses state or its contents become undefined in the case of an interruption of power (e.g., either via a reboot or a power cycle) to client device 210, the contents of storage 220 are non-volatile and retain their state even in the event of an interruption of power to client device 210. Storage 220 stores code for programs that may be executed on client device 210. For example, storage 220 includes browser code 222, which represents code and configuration data for executing a web browser. Browser 232 is initiated by executing browser code 222. Typically, browser code 222 is loaded into memory 250, and executed on processor 260. In the Figure, contents are represented as being loaded on memory 250 by the dashed line, which has the arrow pointing to memory 250. Each element within the dashed line may be understood to be loaded at some point within memory 250.

In addition to browser code 222, in one embodiment, storage 220 includes applet class 224, from which applet 234 is instantiated when browser 232 is executed, or in response to an action by browser 232 or another application that causes applet 234 to execute under or within the context of browser 232. Applet class 224 includes within its code, or via access to a library or other mechanism, remote invoke capability 226. Remote invoke 226 enables instantiated applet 234 to access an application from a separate server and instantiate or initiate execution of the application locally on client device 210 under browser 232. Thus, system 200 includes an illustration of application 236 under browser 232, which may execute within the context of browser 232. Application 236 is automatically initiated upon initiation of applet 234. Application 236 is an instantiation of application code 242, which is hosted by server 240, which is remote from client device 210, as shown by the broken arrow line.

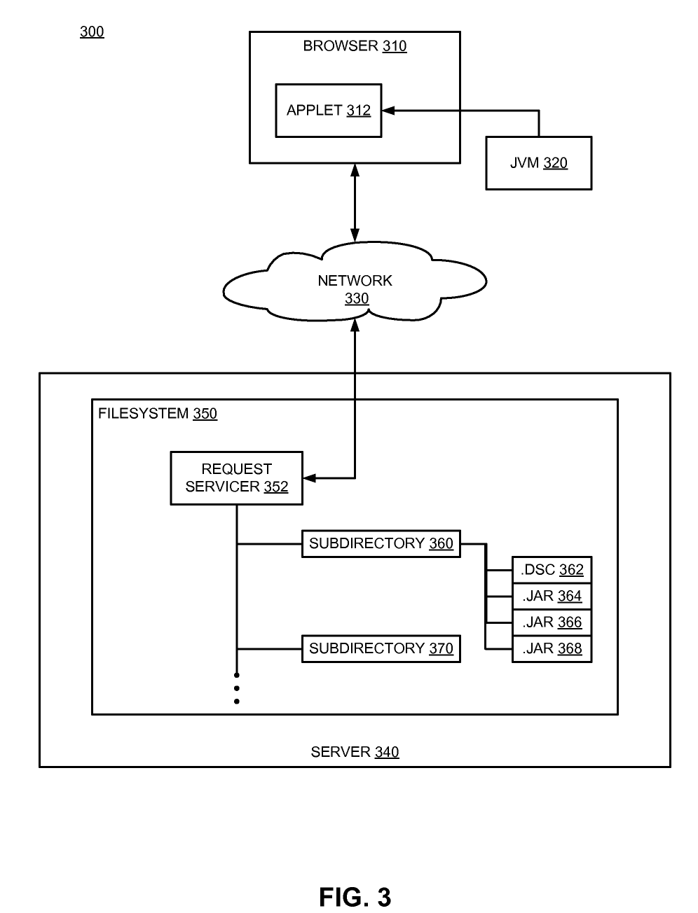

FIG. 3 is a block diagram of an embodiment of a system with an applet that begins execution of a remote application. System 300 illustrates an implementation of the storage and subsequent access of the components of an application that is initiated by instantiation of an applet. System 300 and its components can be understood as examples of systems and components as previously discussed herein. Browser 310 of system 300 initiates execution of applet 312. Browser 310 includes the functionality of JVM 320, which represents a runtime engine that enables the features of applet 312, including a remote invocation feature. Browser 310, via applet 312, accesses server 340 via network 330.

In one embodiment, server 340 includes filesystem 350, which represents a management system that presents or represents the physical storage of one or more applications hosted on server 340. Within filesystem 350, server 340 includes request servicer 352. Request servicer 352 represents a service interface component of filesystem 350, and may be a web service request processing interface. A request is received (e.g., an HTTP get request), and request servicer 352 determines what file or files are requested, and what directory and/or subdirectory contains the requested files. In one embodiment, determining what file or files are requested includes sending a directory or listing of available applications to applet 312, which applet 312 can render on a user interface of browser 310 to allow a user to select an application. In response to a specific request for a specific application or file (either through a user reply, or via an initial request from the applet, such as based on a dependency), request servicer 352 accesses files representing the selected application to enable applet 312 to download the files.

In one embodiment, filesystem 350 includes multiple subdirectories, such as subdirectory 360 and subdirectory 370, where each subdirectory includes a separate application. As an example, consider subdirectory 360 having a description file, .dsc 362, and several application component files, .jars 364-368. Description file 362 may describe the components for the application, and the component files 364-368 include the data for the application. Request servicer 352 may provide description file 362 in response to the request for the application of subdirectory 360, which enables applet 312 to have information that allows it to directly request the component files. Thus, the components of the application can be accessed and initiated on a client device of browser 310.

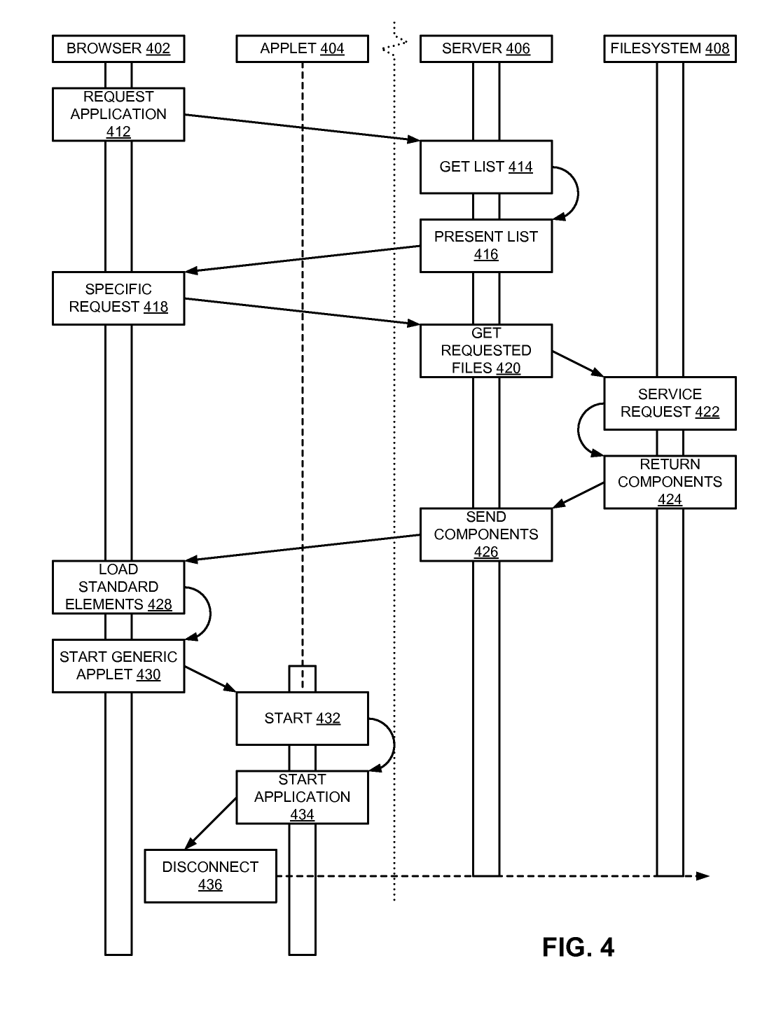

FIG. 4 is a flow diagram of an embodiment of a process of beginning local execution at a client device of a remote application. A flow diagram as illustrated herein provides examples of sequences of various process actions. Although shown in a particular sequence or order, unless otherwise specified, the order of the actions can be modified. Thus, the illustrated implementation should be understood only as an example, and the process for establishing the secure channel can be performed in a different order, and some actions may be performed in parallel. Additionally, one or more action can be omitted in various embodiments of the invention; thus, not all actions are required in every implementation. Other process flows are possible.

Browser 402, applet 404, server 406, and filesystem 408 may be examples of implementations of any such elements as described herein. Browser 402 is started, which initiates the start of applet 404. In one embodiment, applet 404 cannot start until components of a remote application are loaded. For example, the functionality of the applet may be to execute the remote application. Thus, browser 402 would initiate applet 404, but in order to do so, it will obtain components of a remote application. Browser 402 requests an application, 412, from server 406. In one embodiment, server 406 gets a list, 414, representing applications hosted on server 406 on the particular interface on which the request came from browser 402. Note that there may be multiple interfaces to server 406, and each interface may provide access to different applications. Server 406 presents the list, 416, to browser 402.

Browser 402 or a user of browser 402 can select from the list to identify a specific application that is wanted. The selection of the application generates a specific request, 418, that browser 402 sends to server 406. Server 406 generates one or more commands or requests to get the files of the requested application, 420. Specifically, the commands or requests are generated by an interface component with which browser 402 interfaces. Filesystem 408 receives the service request, 422, and returns components that represent the application, 424. The service interface elements of server 406 send the components, 426, to browser 402.

In response to receiving the components, browser 402 loads standard elements, 428, such as those elements or functional blocks in a runtime engine or JVM. Browser 402 then instantiates the applet to start the generic applet, 430. Note that in one embodiment, the applet is a generic applet, rather than an applet that provides specific functionality. The functionality of the applet will be the application that will run under the browser. The applet can simply provide a framework in which the application can be accessed and executed. Thus, applet 404 can be a generic applet in the sense that it provides interface components to execute any application obtained from server 406.

In response to the instantiation of the applet by browser 402, applet 404 starts, 432. Applet 404 then starts the application represented by the components, 434. The application starts in response to the initiation of the applet. After obtaining the components of the application and starting the application, the browser or the client device could even be disconnected, 436, from server 406. The application is able to execute locally on the client device without a connection to the server that hosts the application.

Various components described herein may be a means for performing the functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Software content (e.g., data, instructions, configuration) may be provided via an article of manufacture including a machine readable medium, which provides content that represents instructions that can be executed. The content may result in a machine performing various functions/operations described herein. A machine readable medium includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A machine readable medium may also include a storage or database from which content can be downloaded. A machine readable medium may also include a device or product having content stored thereon at a time of sale or delivery. Thus, delivering a device with stored content, or offering content for download over a communication medium may be understood as providing an article of manufacture with such content described herein.

Besides what is described herein, various modifications may be made to the disclosed embodiments and implementations of the invention without departing from their scope. Therefore, the illustrations and examples herein should be construed in an illustrative, and not a restrictive sense. Additional material attached hereto provides further details and more concepts that are part of this disclosure. The scope of the invention can be identified based on the materials herein, as well as the claims that follow.

What is claimed is:

1. On a client device, a method comprising:
starting execution of an applet in response to beginning execution of a web browser;
connecting via the applet to a server separate from the client device, in response to starting execution of the applet;
downloading from the server, via the applet, functional components of a standalone application; and
executing the application locally on the client device under the web browser.

2. The method of claim 1, wherein beginning execution of the applet comprises:
starting the applet under a JVM (JAVA Virtual Machine).

3. The method of claim 1, wherein connecting to the server comprises:
connecting to a HyperText Transfer Protocol (HTTP) server.

4. The method of claim 3, wherein connecting to the HTTP server comprises:
connecting to a web server.

5. The method of claim 1, wherein downloading functional components of the standalone application comprises:
reading with the applet a description file of the standalone application; and
downloading functional components indicated in the description file.

6. The method of claim 1, wherein downloading functional components of the standalone application comprises:
reading with the applet a filesystem local to the server; and
downloading files from the filesystem corresponding to the functional components.

7. The method of claim 6, wherein each subdirectory of the filesystem represents a separate application.

8. The method of claim 1, wherein executing the application locally comprises:
executing the functional components to execute a SWING application.

9. The method of claim 1, further comprising:
receiving a selectable list of applications available from the server in response to connecting to the server;
sending a request for one of the applications; and
receiving an indication of a location of the functional components of the selected application to enable downloading the functional components.

10. The method of claim 1, further comprising:
disconnecting from the server after downloading the functional components of the standalone application; and
executing the standalone application locally on the client device after disconnecting from the server.

11. An article of manufacture comprising a machine readable medium having content stored thereon to provide instructions to cause a machine to perform operations, including:
instantiating a plugin on a client device in response to starting execution of a web browser on local resources of the client device, the plugin having code that defines accessing and executing a remote application;
accessing a server separate from the client device in response to instantiating the plugin to obtain functional components of the application;
downloading from the server, via the plugin, the functional components of the application; and
executing the application locally on the local resources of the client device.

12. The article of manufacture of claim 11, wherein the content to provide instructions for instantiating the plugin having code that defines accessing and executing the remote application comprises content to provide instructions for
instantiating a plugin having dependencies on the functional components that cause the functional components to be accessed when the plugin is instantiated.

13. The article of manufacture of claim 11, wherein the content to provide instructions for accessing the server to obtain functional components of the application further comprises content to provide instructions for
accessing a list of applications for which functional components could be downloaded;
selecting one of the applications; and
accessing the functional components of the selected application.

14. The article of manufacture of claim 11, wherein the content to provide instructions for the accessing, downloading, and executing comprises content for
performing an introspection invoke method.

15. The article of manufacture of claim 11, wherein the content to provide instructions for instantiating the plugin comprises content to provide instructions for
instantiating a JAVA applet under via a JAVA virtual machine (JVM).

16. The article of manufacture of claim 11, further comprising content to provide instructions for
restarting the plugin;
newly accessing the functional components from the server, the functional components including updated content reflecting an update in the application; and
restarting the application locally on the client device with the updated content.

17. An apparatus comprising:
a processor to execute operations;
a memory device coupled to the processor to store data and instructions for operations of the processor; and
a storage device coupled to the memory to provide data and instructions to the memory, the storage device having code stored thereon representing an operating system to execute on the apparatus, code representing a web browser to execute under the operating system, and code representing an applet to execute under the web browser, the applet having code representing an introspection invoke routine for execution by the processor;
wherein the applet begins execution under the web browser in response to the beginning of execution of the web browser, the beginning of execution of the applet initiating the introspection invoke routine to invoke execution on the apparatus of a standalone application stored on a server separate from the apparatus, the execution of the standalone application invoked via a web service framework.

18. The apparatus of claim 17, wherein the applet invokes the standalone application via a web service interface infrastructure.

19. The apparatus of claim 17, wherein the applet includes a dependency on a component of the standalone application that requires the application to be loaded in response to beginning execution of the applet.

20. The apparatus of claim 17, wherein the applet is a generic applet that does not have specific functionality, and which simply provides a framework to execute the standalone application.

21. The apparatus of claim 17, wherein the web browser includes a JAVA virtual machine that provides a runtime engine to execute the applet.
